(19) United States
(12) Patent Application Publication
(10) Pub. No.: US 2010/0160658 A1
(43) Pub. Date: Jun. 24, 2010

(54) Mechanical Partial Desolventizing System and Process

(76) Inventor: Timothy G. Kemper, Marietta, GA (US)

Correspondence Address: WEGMAN, HESSLER & VANDERBURG, 6055 ROCKSIDE WOODS BOULEVARD, SUITE 200, CLEVELAND, OH, 44131, US

(21) Appl. No.: 11/992,640

(22) PCT Filed: Oct. 24, 2006
(86) PCT No.: PCT/US06/41659

§ 371 Date: Mar. 26, 2008

Related U.S. Application Data
(60) Provisional application No. 60/734,628, filed on Nov. 8, 2005.

(51) Int. Cl. C11B 1/10; B01D 11/02

(52) U.S. Cl. 554/15; 554/12; 422/281

(57) ABSTRACT

Improved system and process for separating the initial portion of liquid solvent from spent oleaginous material after the solvent extraction process and prior to the thermal desolventizing process. Solvent laden solids departing the solvent extraction process are subjected to mechanical pressure to squeeze a portion of the liquid solvent through a perforated surface, into a collection hopper. This liquid solvent is subsequently recycled back to the solvent extraction process for liquid clarification and additional oil recovery.

### CROSS REFERENCE TO RELATED APPLICATION

This application claims the priority benefit of U.S. Provisional Patent Application Ser. No. 60/734,628 filed Nov. 8, 2005.

### BACKGROUND OF THE INVENTION

1. Field of Invention

The invention relates a system and process for extracting oil from oleaginous materials and desolventizing the meal, and more specifically, a system and process incorporating a mechanical partial desolventizing apparatus and step.

2. Description of Related Art

It is well known in the art to extract oils and fats from oleaginous materials such as soybean flakes, rapeseed cake, sunflower cake, peanuts, sesame seeds, cotton seeds, and the like, by grinding the oleaginous material to form grains or flakes and then extracting the oil using a solvent extraction process. The edible oil fraction from the oleaginous material is separated from the protein-rich solid fraction by passing the solvent through the granular solid material to separate the extractable oil, with benzene, propane, butane, pentane, hexane, or mixed solvents, such as mixtures of the above-mentioned hydrocarbons with alcohols, ketones, or generally polar solvents being the preferred solvents or extractants. U.S. Pat. No. 5,705,133 to Kemper et al. discloses a typical stationary screen extractor.

In the typical solvent extraction process, multiple countercurrent stages of miscella (i.e., the oil/solvent solution which has passed through the granular material at least once) with declining concentration of edible oil are washed through the oleaginous material followed by one final wash with fresh solvent. The miscella formed in the extraction of the above-mentioned raw materials is typically separated from the spent solids and forwarded for further processing such as purification or distillation, or the like. After the final washing step, the solid material typically contains less than 1 wt % of edible oil and approximately 40-50 wt % solvent. After up to 30 minutes of gravity drainage at the end of the extraction process, the extracted solid material typically contains between 28-33 wt % solvent.

The spent solids of the extraction process, that is, the mixture of meal and remaining solvent and oil, are then conveyed to a thermal desolventizing apparatus for the purposes of recovering the solvent and obtaining a low-solvent or solvent-free meal. Processes and systems suitable for desolventizing solvent extracted solids have long been known. In these devices, solvent is typically evaporated from the spent solids by steam or steam-containing fluids with the solvent returned to a recovery apparatus such as a fractional distillation unit or the like in a mostly continuous operation. For example, U.S. Pat. No. 5,992,050 to Kemper et al. and U.S. Pat. No. 6,279,259 to Anderson disclose desolventizing processes of the countercurrent steam injection type for separating solvent from solvent-laden solids.

In a typical thermal desolventizing process, the spent solids are initially stirred above indirect steam-heated trays or in steam jacketed tubes. Heat from these trays or tubes is conducted into the spent solids to increase temperature to 145-155° F. and to evaporate the solvent content from 28-33% down to approximately 23-28%. The spent solids are then subjected to live steam in the next stage of the desolventizing process. Live steam condenses into the spent solids. The heat of condensation from the steam is used to further increase the temperature to 210-225° F. and to evaporate the remaining solvent.

U.S. Pat. No. 4,428,833 to Barger made an attempt to augment gravity drainage after the extraction process. However, this concept experienced two practical problems. First, it was not possible to effectively use a vacuum to pull additional solvent from the spent solids due to the difficulty of maintaining a material seal in the drainer conveyor. Secondly, the small amount of additional liquid that gravity drained (without the use of vacuum) contained a high solids content and plugged the pump suction.

There is a need for an improved more efficient extraction and desolventizing process for oleaginous materials.

### SUMMARY OF THE INVENTION

Spent solids, typically containing 28-33% solvent, are pressed against a perforated surface after the extraction process and prior to the thermal desolventizing process. The pressure applied forces a portion of the solvent through the perforated surface into a collection hopper. The liquid flow from one stage of the extractor pours through the collection hopper, mixing with the expelled solvent and any solids it may contain. The liquid from the collection hopper drains to a miscella stage pump and is directed back to the extractor for recovery. After a portion of the solvent is expelled from the extracted solids, the remaining extracted solids, typically containing about 22-27% solvent, are conveyed forward to the thermal desolventizing process.

One aspect of the invention is directed to a method of extracting oil from an oil-bearing solid material and desolventizing the spent solid material. The method includes the steps of contacting a solvent with oil-bearing solid material in an extractor to form (i) miscella and (ii) solid material impregnated with residual solvent and reduced amounts of oil therein. The miscella is separated from the solvent-impregnated solid material. Next, the method includes mechanically pressing the solvent-impregnated solid material to express solvent and oil therefrom, thereby reducing the solvent and oil content of the solid material. The solid material is then passed to a thermal desolventizing apparatus and the solvent and oil expressed from the solid material is collected. At least a portion of the collected solvent and oil is the recirculated through oil-bearing solid material in the extractor.

Another aspect of the invention is a system for extracting oil from an oil-bearing solid material and desolventizing the spent solid material. The system includes an extracting apparatus that contacts a solvent with oil-bearing solid material to form miscella and solid material impregnated with residual solvent and reduced amounts of oil. The system also includes a mechanical partial desolventizing apparatus comprising a mechanical press having a perforated surface through which solvent and oil is expressed from the solvent-impregnated solid material and a hopper for collecting the expressed solvent/oil mixture, and a recirculating pump for recirculating at least a portion of said solvent and oil collected in the hopper to the extractor apparatus. The system also includes a thermal desolventizing apparatus positioned to receive the solid material leaving the mechanical partial desolventizing apparatus.

It has been determined that with light squeezing, solvent can be readily expelled from the spent solids after the extraction process, prior to the thermal desolventizing process. It has been further determined that various mechanical means exist which can separate the initial solvent from the spent solids using mechanically generated pressure, at a lower energy cost than the present state-of-the-art thermal desolventizing process. By removing a portion of the solvent in the spent material prior to thermal desolventizing, the indirect steam pre-desolventizing section of the desolventizing process can be significantly reduced in size to save capital cost in additional to thermal energy.

The mechanical apparatus for applying the pressure to a layer of extracted solids against a perforated surface can be an actuated piston and ram, actuated hinged pressure device, or rotational screw with increasing body diameter. The perforated surface can be the flat extractor screen in combination with an actuated piston and ram, a flat screen in the discharge hopper of the extractor or discharge conveyor in combination with an actuated hinged pressure device, or a circular screen in combination with a rotational screw with increasing body diameter or downstream back pressure device. It is to be understood that the invention is not limited to one of these precise exemplary embodiments of acceptable apparatus, and that changes may be made therein without departing from the scope of the invention.

These and other objects, features, and advantages of the present invention will become apparent to one skilled in the art upon examination and analysis of the following description in view of the accompanying drawings.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 is a schematic diagram depicting a system for extracting oil from oleaginous materials and desolventizing the meal having a mechanical partial desolventizing apparatus; and

FIG. 2 is a flowchart of a process for, operating the system of FIG. 1 according to the invention.

Corresponding reference characters indicate corresponding parts throughout the views of the drawings.

### DETAILED DESCRIPTION OF EXEMPLARY EMBODIMENTS

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

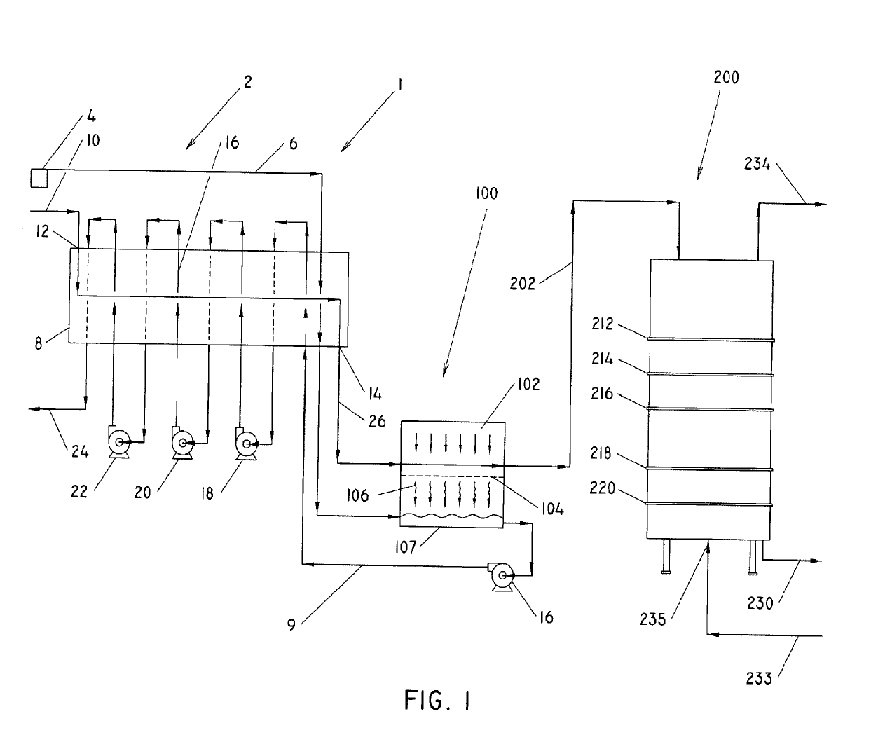

Turning now to FIG. 1, there is shown a schematic diagram illustrating an extraction and desoventizing system, indicated generally at 1, for use with oleaginous material. The system 1 has three primary components, namely an extraction apparatus 2, a mechanical partial desolventizing apparatus 100, and a thermal desolventizing apparatus 200. As will be described below, the system 1 extracts oil from oleaginous materials with a solvent and desolventizes the remaining meal.

Turning first to the extraction apparatus 2, here the extraction of oil from oleaginous material is effected in an extractor 8 of the countercurrent wash type. As shown, solvent, such as hexane, is fed from a reservoir 4 through feedline 6 and eventually is feed into the extractor 8 through conduit 9. Oil-bearing solid material enters the extractor 8 at inlet 12 through chute 10 and exits from the extractor 8 at exit outlet 14. The oil-bearing solid material travels through the extractor 8 from an upstream to downstream direction from inlet 12 to exit 14 through a method known in the art, whereas the solvent travels from a downstream direction to the upstream direction in the extractor 8 via conduit 9 and pumps 16, 18, 20, and 22 which convey the solvent in countercurrent washing contact with the oil-bearing solid material.

Miscella, a mixture of the extracted oil and solvent, exits the extractor 8 via line 24 for further processing leading to the isolation of the oil from the solvent using any known method. Solid material impregnated with residual solvent and a minor amount of oil (e.g., about 0.5-1% oil based on the weight of solvent) is conveyed via line or conveyor 26 into the mechanical partial desolventizing apparatus 100. It is to be noted that although this one particular extraction apparatus 2 is shown for illustrative purposes, a variety of other extractors such as the stationary screen extractor shown in U.S. Pat. No. 5,705,133 or other countercurrent solvent wash extractors are known in the art and can be utilized in accordance with the invention.

Turning now to the mechanical partial desolventizing apparatus 100 portion of FIG. 1, the solvent-impregnated solid material is carried via line or conveyor 26 to a mechanical press 102. Mechanical pressure is applied to the solvent-impregnated solid material by the mechanical press 102 so as to express an oil/solvent mixture 106 therefrom. The expressed oil/solvent mixture 106 is collected in a sump or collection hopper 107. The oil/solvent mixture 106 is mixed with the solvent from reservoir 4 that is carried via feed line 6 and is removed from the hopper 107 via the action of pump 16 and recycled to the extractor 8 via line 9. It has been determined that by allowing the entire miscella flow from an extraction process stage to flow through the collection hopper 107, a sufficiently high flow rate is provided that prevents solids that are expelled out with the liquid solvent from plugging the discharge pump 16. As shown, the mechanical press 102 exerts pressure through a perforated surface 104 with recovered oil/solvent mixture 106 collected in the hopper 107. Suitable mechanical presses 102 may comprise screw press devices, ram presses, or hinged platen type mechanisms as well as others within the sound technical judgment of the artisan.

It is noted that the mechanical partial desolventizing apparatus 100 can also be formed as part of the discharge hopper area of the extractor 8 itself or in conjunction with the discharge conveyor 26. For example, in either or both of these locations, a hinged actuated pressure plate pressing material against a slotted screen surface would function to provide the requisite mechanical partial desolventizing.

After passing through the mechanical partial desolventizing apparatus 100, the partially desolventized solid material is forwarded via line 202 into the inlet end of a thermal desolventizing apparatus, shown schematically at 200. As shown, the desolventizer apparatus 200 is of the multiple tray type wherein trays 212-220 are provided in an upstream to downstream direction with steam entering the device via inlet 233 traveling upwardly (i.e., counter currently with regard to the solids travel) to heat via direct and indirect means, the partially desolventized material to further reduce the solvent content thereof. Typically, the upstream section of the desolventizer apparatus 200 is provided with a plurality of indirect heating zone trays 212, 214, 216 which permit indirect steam contact with the meal. A lower direct heating zone is also provided that is adapted to provide for countercurrent steam stripping wherein the solvent vapors from one direct heating zone are vented to the next highest adjacent tray in the column. The bottom most tray 220 is provided with a nozzle 235 for the steam injection inlet 233 or the like.

As the partially desolventized material travels from an upstream to downstream direction in the desolventizer apparatus 200, solvent is reduced with the desolventized solid material exiting at downstream exit 230. The counter currently flowing steam strips or helps to vaporize the remaining solvent in the solid material and exits via conduit 234 provided toward the upstream end of the desolventizer apparatus 200. It is noted that desolventizers of the type noted in U.S. Pat. Nos. 6,279,250 and 5,992,050 may be employed in accordance with the invention in addition to a variety of other commonly used desolventizing apparatii.

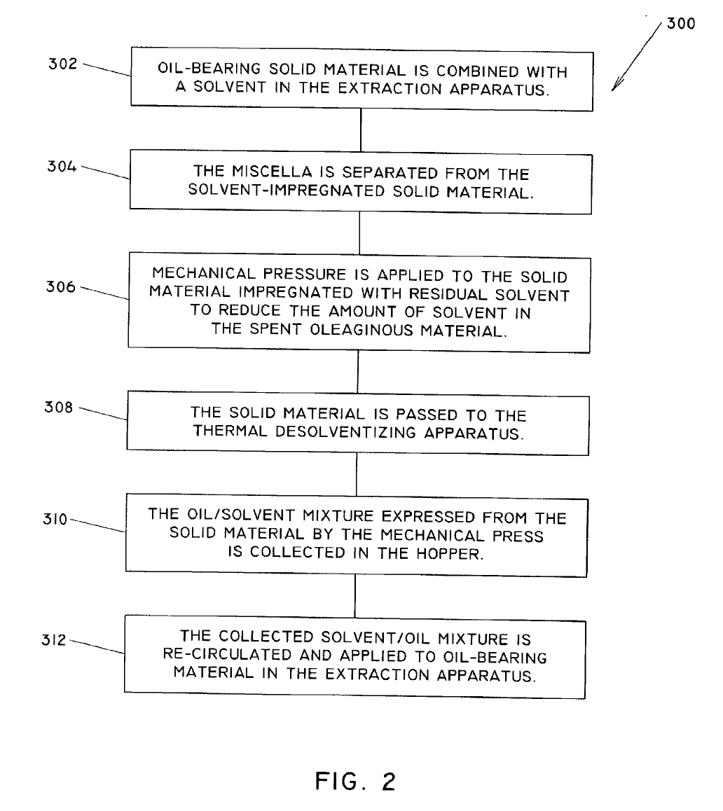

Operation of the system 1 illustrated in FIG. 1 will now be described with respect to the flow chart of FIG. 2. FIG. 2 illustrates a process 300 for extracting oil from oleaginous materials and desolventizing the meal that incorporates a mechanical partial desolventizing step using the mechanical partial desolventizing apparatus 100. As can be seen, the mechanical partial desoventizing step occurs after the solid material passes through the extraction apparatus 2 and prior to entry into the thermal desolventizing apparatus 200. According to the invention as set forth above, the mechanical partial desolventizing step performed by the mechanical partial desolventizing apparatus 100 includes the application of mechanical pressure to the solvent-impregnated solid material to expel a portion of the solvent through the perforated surface 104 and the collection of the expelled solvent in the hopper 107. The expelled solvent is then re-circulated in the extractor 8.

In step 302, oil-bearing solid material is combined with a solvent in the extraction apparatus 2 to form miscella having mixed oil and solvent therein and solid material impregnated with residual solvent and minor amounts of oil therein.

In step 304, the miscella is separated from the solvent-impregnated solid material by the extractor 8 such that the miscella exits the extractor through line 24 and the solid material leaves the extractor 8 through exit 14.

In step 306, mechanical pressure is applied to the solid material impregnated with residual solvent to reduce the amount of solvent in the spent oleaginous material. Desirably, the mechanical press 102 applies mechanical pressure to the solvent-impregnated solid material to reduce the solvent content from 28-50 wt % down to about 15-27 wt % prior to entry into the thermal desolventizing apparatus 200. More preferably, mechanical pressure is utilized to reduce solvent in the spent oleaginous material from between 28 to 33 wt % down to between 22 to 27 wt % prior to thermal desolventizing. In step 308, the solid material is passed to the thermal desolventizing apparatus 200.

In step 310, the oil/solvent mixture 106 expressed from the solid material by the mechanical press 102 is collected in the hopper 107. In step 312, at least a portion of the solvent/oil mixture 106 recovered in step 310 is re-circulated and applied to the oil-bearing material in the extraction apparatus 2 as step 302 is repeated. Desirably, the lowest oil concentration miscella stage pump 16 from the extraction apparatus 2 collects the expelled solvent 106 in the hopper 107 and pumps it to the extractor 8. However, one skilled in the art will understand that the miscella can flow through the hopper 107 at any stage of its path through the extractor 8 and any of the pumps 18, 20, 22 can be used to recirculate the solvent/oil mixture 106 collected in the hopper. Adding additional recirculation means, i.e., pumps 18, 20, and 22 in operative association within the extractor 8 further increases oil yield and permits the recovery of 0.5-1.0% edible oil fraction remaining in the expelled solvent/oil mixture 106.

It has been determined that little additional energy is required to mechanically expel solvent content from 40-50% down to about 22-27%, versus the energy to mechanically expel solvent content from 28-33% down to about 22-27%. Without being limited by such disclosure, it has been found that using the mechanical partial desolventizing process 300 permits the reduction of gravity drainage time at the end of the extraction process from 15-30 minutes to about 5 minutes or less. This advantageously increases the capacity or yield of existing extractors 8. The additional extraction volume gained can then be utilized for additional countercurrent washes to improve extraction yield or capacity.

By removing a portion of the solvent in the spent material prior to thermal desolventizing, the indirect steam pre-desolventizing section of the desolventizing process can be significantly reduced in size to save capital cost in additional to thermal energy. The mechanical partial desolventizing process 300 also permits the reduction of thermal pre-desolventizing indirect heating surface at the beginning of the thermal desolventizing apparatus 200 to less than 2 square feet per ton per hour of oleaginous material processed.

It has been discovered that expelling solvent with the mechanical press 102 to below approximately 20% becomes more energy intensive than traditional thermal desolventizing. In addition, if the solvent is expelled below 20% before entering the thermal desolventizing process, there will be insufficient live steam condensation in the desolventizing process to develop sufficient moisture content to deactivate anti-nutritional factors in the solids. Therefore, it has been determined that mechanically expelling the solvent from the spent solids is best applied as a first step before a traditional thermal desolventizing process.

With a typical solvent content of 28-33% entering the thermal desolventizing process, the resultant moisture of the spent solids during the thermal desolventizing process is 18-21%, typically providing a PDI (protein dispersibility index) in the solids fraction of 25-30%. By reducing the solvent content in the solid material with the mechanical press 102 to about 22-27% entering the thermal desolventizing apparatus 200, the resultant moisture of the spent solids during the thermal desolventizing process reduces to 15-18%, providing a higher PDI (protein dispersibility index) of 30-35% in the solids fraction. Higher PDI increases the digestibility of the protein in the solids fraction and its relative value to poultry and swine protein efficiency ratio. Therefore, the process 300 produces over 30% PDI (protein dispersibility index) solids fraction after the thermal desolventizing process as a result of lower incoming solvent content and lower resultant moisture content during thermal desolventizing.

The solvent that is entrained with the spent material typically leaving the extraction process typically contains 0.5-1.0% edible oil. Any solvent that is evaporated in the downstream thermal desolventizing process leaves its residual oil fraction behind in the solids fraction. The portion of solvent that can be removed mechanically remains in a liquid state, and can be returned to the extraction process to have this residual oil recovered, thereby, improving oil recovery yield.

While this invention has been described in conjunction with the specific embodiments described above, it is evident that many alternatives, combinations, modifications and variations are apparent to those skilled in the art. Accordingly, the preferred embodiments of this invention, as set forth above are intended to be illustrative only, and not in a limiting sense. Various changes can be made without departing from the spirit and scope of this invention.

What is claimed is:

1. A method of extracting oil from an oil-bearing solid material and desolventizing the spent solid material, the method comprising:
(a) contacting a solvent with oil-bearing solid material in an extractor to form (i) miscella and (ii) solid material impregnated with residual solvent and reduced amounts of oil therein;
(b) separating the miscella from the solvent-impregnated solid material;
(c) mechanically pressing said solvent-impregnated solid material to express solvent and oil therefrom, thereby reducing the solvent and oil content of the solid material;
(d) passing the solid material to a thermal desolventizing apparatus;
(e) collecting the solvent and oil expressed from said solid material in said step (c); and
(f) recirculating at least a portion of said solvent and oil collected in step (e) through oil-bearing solid material in said extractor.

2. Method as recited in claim 1 wherein said solid material (ii) in said step (a) comprises solvent and about 0.5-1% oil based on the weight of solvent in (ii).

3. Method as recited in claim 1 wherein said solid material, after said step (c) comprises about 22 to about 27 wt % solvent.

4. Method as recited in claim 1 wherein said step (d) results in a solid material having over 30% PDI (protein dispersibility index).

5. Method as recited in claim 4 wherein said step (d) comprises contacting said solid material with steam.

6. Method as recited in claim 5 wherein said step (e) comprises countercurrent indirect and direct steam contact with said solid materials.

7. Method as recited in claim 1 wherein said step (a) is performed in a stationary screen extractor.

8. Method as recited in claim 1 wherein said step (a) is performed in a countercurrent solvent wash extractor.

9. Method as recited in claim 8 wherein said oil-bearing solid material travels from an upstream to downstream direction in said extractor and said solvent travels countercurrent to said solid material and contacts said oil-bearing solid material at plural stages within said extractor.

10. Method as recited in claim 10 wherein said extractor comprises plural pumps extending from an upstream direction to a downstream direction for pumping said solvent counter currently with respect to said traveling solid material, said collected solvent from said step (e) being conveyed to a downstream one of said plural pumps.

11. Method as recited in claim 11 wherein said collected solvent and oil from said step (e) are conveyed to the most downstream of said pumps.

12. Method as recited in claim 1 wherein said oil bearing solid material is a member selected from the group consisting of soybean flakes, rapeseed cake, sunflower cake, peanuts, sesame seeds, and cotton seeds.

13. Method as recited in claim 1 wherein said solvent is hexane.

14. Method as recited in claim 1 wherein said step (c) is performed in a screw press apparatus.

15. Method as recited in claim 1 wherein said step (c) is performed in a piston ram press.

16. A system for extracting oil from an oil-bearing solid material and desolventizing the spent solid material, the system comprising:
an extracting apparatus that contacts a solvent with oil-bearing solid material to form miscella and solid material impregnated with residual solvent and reduced amounts of oil;
a mechanical partial desolventizing apparatus comprising a mechanical press having a perforated surface through which solvent and oil is expressed from the solvent-impregnated solid material and a hopper for collecting the expressed solvent/oil mixture, and a recirculating pump for recirculating at least a portion of said solvent and oil collected in said hopper to the extractor apparatus; and
a thermal desolventizing apparatus positioned to receive the solid material leaving the mechanical partial desolventizing apparatus.

17. The system as recited in claim 16 wherein the mechanical press is a screw press.

18. The system as recited in claim 16 wherein the mechanical press is a piston ram press.

19. The system as recited in claim 16 wherein the oil-bearing solid material travels from an upstream to downstream direction in said extractor apparatus and said solvent travels countercurrent to said solid material and contacts said oil-bearing solid material at plural stages within said extractor apparatus

20. The system as recited in claim 16 wherein said extractor apparatus comprises plural pumps extending from an upstream direction to a downstream direction for pumping said solvent counter currently with respect to said traveling solid material, said collected solvent from said hopper is conveyed to a downstream one of said plural pumps.
